(19) United States
(12) Patent Application Publication
(10) Pub. No.: US 2013/0232732 A1
(43) Pub. Date: Sep. 12, 2013

(54) Hook Device

(71) Applicants: Jeffrey D. Jacobson, Seattle, WA (US); Jack M. Jacobson, Walla Walla, WA (US)

(72) Inventors: Jeffrey D. Jacobson, Seattle, WA (US); Jack M. Jacobson, Walla Walla, WA (US)

(21) Appl. No.: 13/589,455

(22) Filed: Aug. 20, 2012

Related U.S. Application Data
(60) Provisional application No. 61/634,845, filed on Mar. 7, 2012.

(51) Int. Cl. F16B 45/00

(52) U.S. Cl. 24/265 H

(57) ABSTRACT

A metal hook that can be attached to an elastic cord. The metal hook includes a loop that can be used to pull, or stretch, a bungee cord toward a location where the hook will be secured, thereby improving a user's control, and safe operation, of the bungee cord. The loop also provides an additional location for securing the opposite hook end of the same bungee cord or the hook of another bungee cord, making the bungee cord more versatile and easier to use.

### CROSS REFERENCE TO RELATED APPLICATIONS

This application claims the benefit of Provisional Patent Application Ser. No. 61/634,845 entitled “Finger Loop for Bungee Cords with Wire Metal Hooks”, filed Mar. 7, 2012, for all purposes including but not limited to the right of priority and benefit of earlier filing date, and expressly incorporates by reference the entire content of Provisional Patent Application Ser. No. 61/634,845.

### BACKGROUND

The invention is in the area of fasteners. More specifically, the invention is directed to the area of metal hooks for bungee cords.

Many bungee cords include wire metal hooks. Such hooks currently require the user to grasp either the hook itself or a portion of the elastic cord near the hook, when the user is stretching the bungee cord to secure it. Grasping the hook while stretching the elastic cord is dangerous because the user can pinch a finger while attempting to secure the hook. Grasping the elastic cord while stretching the elastic cord produces a grip that can be insecure. Loss of control of a stretched bungee cord can cause the bungee cord to snap back toward the user and cause serious injury.

Further, existing bungee cords lack loops on their wire metal hooks. A loopless hook of a bungee cord is difficult to attach to either another hook at the opposite end of the same bungee cord or to a hook of another bungee cord.

In addition, many existing bungee cords have hooks that are permanently attached to an elastic cord, often using a proprietary technique that prevents a user from replacing the elastic cord.

An acceptable mechanism for handling these problems has eluded those skilled in the art, until now.

### SUMMARY

The present invention is directed at a hook with a finger loop for use in connection with one or more bungee cords.

This summary is provided to introduce a selection of concepts in a simplified form that are further described below. This summary is not intended to identify key or essential features of the claimed subject matter, nor is it intended to limit the scope of the invention.

In one aspect, the invention provides a metal hook, the metal hook comprising an open hook end, a coiled end, and a shank connecting the open hook end and the coiled end, the shank having a loop, the loop being located on the side of the shank opposite the open hook end. The coiled end of the metal hook may be connected to an elastic cord.

In another aspect, the invention provides a metal hook, the metal hook comprising a first bend, a second bend, and a shank connecting the first bend and the second bend, the shank having a loop, the loop being located on the side of the shank opposite the first bend. The second bend of the metal hook may be connected to an elastic cord.

### BRIEF DESCRIPTION OF THE DRAWINGS

FIG. 1 is a side view of one embodiment of the invention.

FIG. 2 is a side view of another embodiment of the invention.

### DETAILED DESCRIPTION

What follows is a detailed discussion of certain embodiments of the invention. Briefly stated, the invention provides a metal hook for a bungee cord, the hook having a finger loop which increases a user's safety in working with a bungee cord as well as making it easier to work with the bungee cord. While certain specific embodiments will be described in this document, the impossibility of describing every conceivable embodiment should be noted and appreciated. Accordingly, many other embodiments are possible and the invention is limited only by the scope of the claims appended to this document.

As used throughout this document, the term ‘bungee cord’ shall have its plain and ordinary meaning, and shall include any elastic cord (which may be composed of one or more elastic strands, and may be covered with a sheath) which has a hook on one end or separate hooks on each end. The elastic cord may comprise rubber or any other elastic material. Without limitation, the elastic cord may be an ethylene propylene diene monomer (“EPDM”) rubber strap.

The invention described herein is a metal hook for a bungee cord. One or more metal hooks may be attached to an elastic cord to form a bungee cord before the resulting bungee cord is sold to consumers—alternatively, the metal hook may be manufactured and sold apart from an elastic cord. The metal hook can be made with any metal capable of being stretched into wire, although the inventors have determined that steel wire may be preferable.

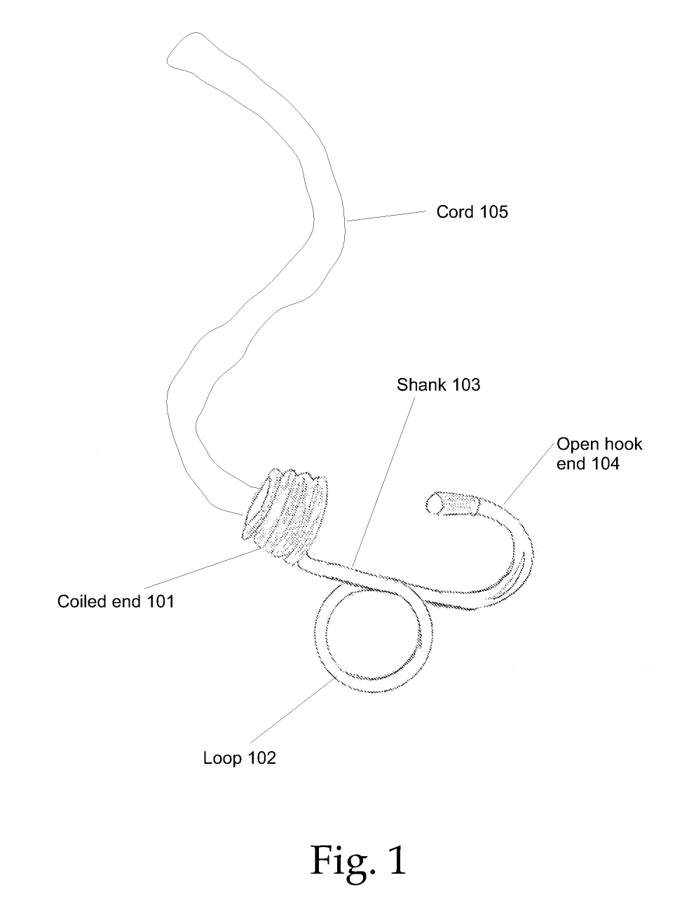

FIG. 1 is a side view of one embodiment of the invention. FIG. 1 illustrates a metal hook that comprises a coiled end 101, a shank 103, and an open hook end 104. In the illustrated embodiment, coiled end 101 is securely attached to a cord 105. Cord 105 may be knotted or folded and stapled at the end that is attached to coiled end 101, thereby securely attaching cord 105 to coiled end 101.

As illustrated, shank 103 has a loop 102. Loop 102 is located on the side of shank 103 opposite open hook end 104. Alternatively, loop 102 may be located on the same side of shank 103 as is open hook end 104. In alternative embodiments, shank 103 may have more than one loop.

The embodiment described in FIG. 1 will allow a user to attach the present invention to an elastic cord having virtually any desired length and any diameter smaller than the opening of coiled end 101. This will make it easier to replace cord 105 as needed or desired.

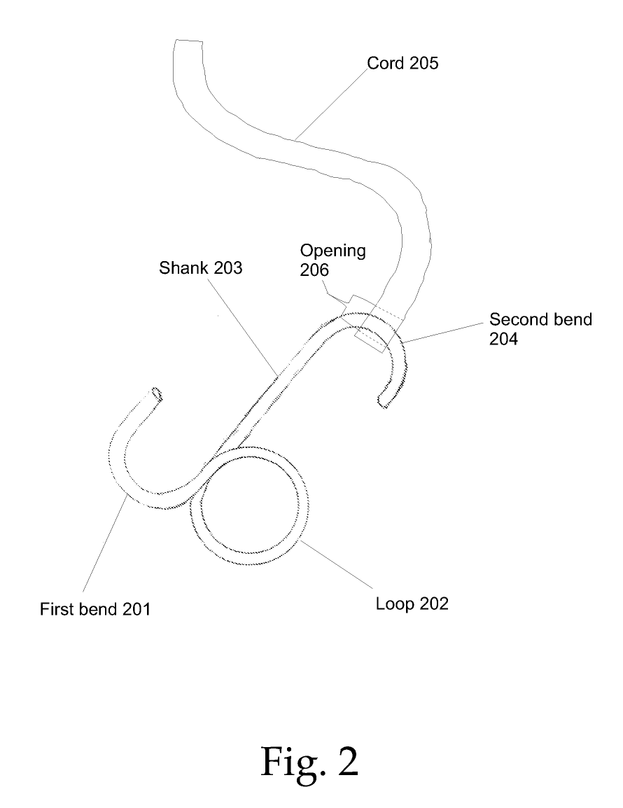

FIG. 2 is a side view of another embodiment of the invention. FIG. 1 illustrates a metal hook that comprises a first bend 201, a shank 203, and a second bend 204. The metal hook may be a standard S-hook. In the illustrated embodiment, second bend 204 is securely attached to a cord 205. As illustrated, cord 205 has an opening 206 (shown by dashed lines) through which second bend 204 has been inserted, thereby securely attaching cord 205 to second bend 204. As illustrated, first bend 201 remains free to be hooked to another object such as another bungee cord.

As illustrated, shank 203 has a loop 202. Loop 202 is located on the side of shank 203 opposite first bend 201. Alternatively, loop 202 may be located on the same side of shank 203 as is first bend 201. In alternative embodiments, shank 203 may have more than one loop.

The embodiment described in FIG. 2 will allow a user to attach the present invention to an elastic cord having virtually any desired length and any opening 206 into which second bend 204 may be inserted. This will make it easier to replace cord 205 as needed or desired.

In the above embodiments, a user can insert one or more fingers into the loop and thereby use the invention to pull, or stretch, a bungee cord toward a location where the hook will be secured, thereby improving a user's control, and safe operation, of the bungee cord. In the above embodiments, the loop also provides an additional location for securing the opposite hook end of the same bungee cord or the hook of another bungee cord, making the bungee cord more versatile and easier to use.

In a preferred embodiment, the metal hook is entirely made from a single, unbroken length of steel wire to maximize strength and integrity of the device. In this embodiment, the compact size of the metal hook makes it easy to grasp and maneuver a bungee cord that is attached to the metal hook. Also, in this preferred embodiment, the loop provides an additional location for securing another hook on the opposite end of the same bungee cord (i.e., an other hook on the end of cord 105, which other hook is not attached to coiled end 101, or an other hook on the end of cord 205, which other hook is not attached to second bend 204) or to one or more hooks of one or more other bungee cords. The benefits of the device may be especially great when maneuvering in a small area, where connection points are few in number or difficult to reach.

As indicated, the metal hook is made from steel wire in this preferred embodiment. A hook made from steel wire is stronger than a hook of similar size made of plastic. This embodiment presents numerous advantages that hooks made of plastic do not. Without limitation, those advantages include the fact that a metal hook can be produced in a compact size, yet retain a relatively large loop for maneuvering a bungee cord and providing a location for securing one or more other hooks when the one or more other hooks are attached to the loop of the metal hook. The relatively small diameter of steel wire makes it easy for a user to attach one or more wire hooks to a loop of a hook made from steel wire.

The use of the present invention will greatly increase the ease of use, and safety of use, of bungee cords with metal hooks. Bungee cord injuries are common and can be severe, with the most common of these serious injuries occurring to the eye. By improving user control of common bungee cords, the present invention can help reduce the number of injuries caused by bungee cords that accidentally recoil.

Although the invention has been described in language specific to particular embodiments or implementations, it should be understood that the subject matter defined by the following claims is not necessarily limited to the specific embodiments or implementations described above. Rather, the specific embodiments described above are provided merely as non-exhaustive examples of implementing the subject matter claimed below.

What is claimed is:

1. A metal hook for a bungee cord, the metal hook comprising:
an open hook end;
a coiled end, wherein the coiled end is capable of being connected to an elastic cord; and
a shank connecting the open hook end and the coiled end, the shank having a loop, the loop being located on the side of the shank opposite the open hook end.

2. The metal hook recited in claim 1, wherein the material comprises wire metal.

3. The metal hook recited in claim 2, wherein the wire metal is steel.

4. The metal hook recited in claim 1, wherein the loop is located on the same side of the shank as is the open hook end.

5. The metal hook recited in claim 1, wherein the shank has two or more loops.

6. A metal hook for a bungee cord, the metal hook comprising:
a first bend;
a second bend, wherein the second bend is capable of being connected to an elastic cord; and
a shank connecting the first bend and the second bend, the shank having a loop, the loop being located on the side of the shank opposite the first bend.

7. The metal hook recited in claim 6, wherein the material comprises wire metal.

8. The metal hook recited in claim 7, wherein the wire metal is steel.

9. The metal hook recited in claim 6, wherein the loop is located on the same side of the shank as is the first bend.

10. The metal hook recited in claim 6, wherein the shank has two or more loops.
